(19) United States
(12) Patent Application Publication
(10) Pub. No.: US 2018/0291646 A1
(43) Pub. Date: Oct. 11, 2018

(54) SOLUTION FOR THE MUTUAL FASTENING OF COMPONENT PARTS OF A CLOSING SYSTEM, IN PARTICULAR FOR DOORS/ WINDOWS

(71) Applicant: MYPRO RESEARCH S.R.L., Thiene (IT)

(72) Inventor: Giancarlo BRUN, Thiene (IT)

(73) Assignee: MYPRO RESEARCH S.R.L., Thiene (IT)

(21) Appl. No.: 15/768,570

(22) PCT Filed: Oct. 19, 2016
(86) PCT No.: PCT/IB2016/056272

§ 371 Date: Apr. 16, 2018

(30) Foreign Application Priority Data
Oct. 23, 2015 (IT) 102015000064698

(51) Int. Cl. E05B 3/04; E05B 15/00

(52) U.S. Cl. CPC E05B 3/04; E05B 2003/006; E05B 15/0033

(57) ABSTRACT

The invention concerns a closing system for doors and/or windows. The system comprises a first male element (20), also commonly called “quadrello” in Italian, intended to move a bolt by rotating it, and a second female element (10) suited to be operated in such a way as to set the male element or “quadrello” (20) rotating. The male element and the female element (20, 10) are suited, when in use and/or when applied, for example, to a door and/or window, to be mutually fixed in a configuration of use, wherein in the configuration of use or operation an end portion of the male element (20) is housed in a first corresponding seat (14) created in the female element (10). The system comprises a closing element (12) suited to mutually lock the male and female elements (20, 10) in the configuration of use or operation. The closing element (12) is housed in a second corresponding seat (11) created in the female element (10) and is configured in such a way that it can be switched in a locked position in which it is engaged with the male element or “quadrello” (20) through the insertion of the end portion of the male element or “quadrello” (20) in the first corresponding seat (14) created in the female element (10).

### TECHNICAL FIELD OF THE INVENTION

The present invention concerns the field of closing systems, in particular for doors, windows or similar elements. In particular, the present invention is related to a closing system of the above mentioned type, comprising a male element, also commonly called “quadrello” in Italian (a usually metallic rigid bar), suited to move a bolt by rotating it, as well as one or more handles, each one of which is suited to be fixed to said male element or “quadrello” and to be operated in such a way as to set said male element rotating, and thus to move the bolt, thus allowing the system and consequently the door/window to which the system is applied to be opened and closed. In further detail, the present invention is related to a solution for the mutual fastening of component parts of a closing system of the above mentioned type, in particular at least of the male element and one handle.

### STATE OF THE KNOWN ART

The closing systems (locks) most commonly known and widely used in practical applications comprise a male element or “quadrello” (a rigid bar, usually metallic with square cross section) whose centre portion is housed in the leaf of a door/window while an end portion (in the case of a single handle) or both the opposite end portions of the male element (in the case of two handles) projects/project from the opposite sides of the door/window leaf itself. The male element, in particular its centre portion, is coupled with a bolt, in such a way that the rotation of the male element in the two opposite directions of rotation results in the switching of the bolt in two corresponding opposite switching directions. Each handle (one or two, depending on the circumstances and/or the needs) is fixed to an end portion of the male element that projects from the door/window leaf, in such a way as to simultaneously define also the position of the handle with respect to the door/window leaf, and furthermore in such a way that the action of a user on the handle results in a rotation of the male element and therefore in the switching of the bolt, in such a way as to alternatively allow the opening and closing of the system and consequently of the door/window leaf. Different solutions have been proposed in the art regarding the mutual fastening of the one or more handles to the male element. Among the simplest solutions, the most widespread includes the use of an externally threaded dowel, whose external thread becomes engaged with the inner thread of a corresponding housing seat for the dowel obtained in the handle, so that the progressive penetration of the dowel in the handle through a screwing action causes the dowel itself to become engaged with the male element and therefore the mutual constraint of the handle and the male element, while on the contrary the extraction of the dowel results in the release of the dowel itself from the male element and thus of the handle from the male element.

Even if they are valuable for several reasons such as, for example, the ease of manufacture and implementation, as well as the decidedly limited costs, the solutions according to the known art of the type described above, however, are not without disadvantages and/or drawbacks.

For example, a first drawback is related to the aesthetic appearance, as the dowel represents a visible element that affects the continuity of the external appearance of the handle.

A second drawback is related to the assembly procedures which, even if simple, however involve the use of tools and/or instruments (screwdrivers, socket wrenches or similar devices), not always immediately available, in particular not always compatible with the characteristics of the dowel itself. Furthermore, the incorrect use of said tools can cause damages to the handle, such as scratches or similar damages.

And again, it is important to take in consideration the risk of the dowel accidentally becoming loose and thus of the handle becoming detached from the male element, wherein the accidental release of the dowel results in the further risk of the dowel itself being lost and needing to be replaced.

Finally, the engagement of the dowel may in any case be such as to not eliminate any slacks of the handle.

It is thus one object of the present invention to overcome or at least minimize the drawbacks and/or inconveniences of the closing systems of the above mentioned type known in the art. In particular, it is a further object of the present invention to provide a solution that allows one or both of the handles of a closing system to be fastened to the corresponding male element or “quadrello” in a mutual and reliable manner. Moreover, it is a further object of the present invention to provide a solution that allows the closing system to be assembled and disassembled, in particular that makes it possible to mutually fasten and constrain at least some of the component parts of a closing system while avoiding the need for any tools and/or instruments.

Furthermore, according to the present invention, the solution must be compatible with the aesthetic appearance of the handle or at least such as not to negatively affect said aesthetic appearance of the handle.

And again, the solution according to the present invention must be such as to avoid any accidental uncoupling of the component parts of a closing system, in particular of one or both of the handles, from the male element or “quadrello”. Finally, according to the present invention, the closing system must be suited to be carried out and assembled through simple or not excessively complicated operations and procedures and at a limited or at least competitive cost.

The objects of the present invention also include the object to provide a solution that allows the component parts to be uncoupled from each other through simple and immediate procedures; for example, in the case of the fastening of two handles to the opposite sides of a door/window, the system must allow the removal of one of the handles (for example, when access to a room has to be prevented).

And again, the system according to the present invention must allow the installation of handles on doors/windows having different thicknesses, avoiding in particular any slacks in or incorrect fastening of the parts involved.

### GENERAL DESCRIPTION OF THE PRESENT INVENTION

A general consideration on which the present invention is based is related to the fact that the set objects and the drawbacks observed in the known art and previously described can be respectively achieved and overcome or at least minimized through a closing system whose assembly procedures involve the automatic constraint of at least some of its component parts. In particular, a further consideration on which the present invention is based is related to the fact that the set objects and the drawbacks observed in the known art can be respectively achieved and overcome or at least minimized through a closing system whose assembly procedures involve the automatic constraint of at least one handle and the corresponding male element or “quadrello”. In this way, in fact, it will be possible to avoid the use of tools and/or instruments, since the mutual constraint is already obtained by positioning the at least one handle and the related male element in the mutual configuration of use.

A further consideration on which the present invention is based is related to the fact that it is possible to obtain an absolutely reliable constraint (which absolutely excludes the risk of accidental uncoupling) between the at least one handle and the corresponding male element when a closing element is provided which is housed inside the handle and shaped in such a way as to enhance the mutual constraint between the at least one handle and the corresponding male element in the case of mutual movements that can be accidental or caused by said at least one handle and the related male element and are opposite those usually performed according to the procedures for the mutual assembly of said at least one handle and the corresponding male element.

Finally, a further consideration on which the present invention is based is related to the fact that also the procedures for the mutual and intentional release of the at least one handle from the corresponding male element can be simplified by allowing the closing element to be switched from the position in which it mutually constrains said at least one handle and the corresponding male element to a position in which said at least one handle and the corresponding male element are not mutually constrained by said closing element, said switching of the closing element being furthermore particularly simple and reliable, as well as suited to be performed without using tools and/or instruments, through a switching element housed in the handle and accessible from the outside of the handle itself.

Based on the general considerations summed up above, the subject of the present invention is a closing system for doors and/or windows, said system comprising a first male element or “quadrello” intended to move a bolt by rotating it, and a second female element suited to be operated in such a way as to set said male element or “quadrello” rotating, said male and female elements being suited, when in use and/or when applied, for example, to a door/window, to be mutually fastened to each other in a configuration of use, wherein in said configuration of use or operation an end portion of said male element is housed in a first corresponding seat created in said female element, said system comprising a closing element for the mutual closing of said male and female elements in said configuration of use or operation, wherein said closing element is housed in a second corresponding seat created in said female element, and wherein said closing element is configured in such a way that it can be switched in a locked position, in which it is engaged with said male element or “quadrello” through the insertion of said end portion of said male element or “quadrello” in said first corresponding seat created in said female element.

According to an embodiment of the invention, said closing element can be shaped in such a way that, once switched in said locked position, any movement of said male element or said female element in the direction contrary to the direction of insertion of its end portion in said first corresponding seat of said female element results in an enhanced mutual engagement of said closing element and said male element or “quadrello”.

According to a possible further embodiment, said closing element may comprise a flexible portion, wherein said flexible portion, when not engaged with said male element, extends along a first rest direction, and wherein said flexible portion, when switched in said locked position, extends along a second direction different from said first direction.

According to a possible further embodiment, said first direction can be substantially perpendicular to the direction of insertion of said male element in said first seat created in said female element and/or said closing element may comprise a free end portion suited to be switched, and wherein, in said engaged position, said free end portion is engaged with said male element or “quadrello”. According to a possible further embodiment, in said locked position said free end portion of said closing element is engaged with an engagement groove or lowered portion of said male element and/or, if necessary, in said locked position, the external edge of said closing element comes into contact with the surface of said engagement groove or lowered portion.

According to a further possible embodiment, said male element or “quadrello” may comprise a thrusting surface that, during the insertion of said male element in said corresponding seat created in said female element, exerts a thrusting action on said free end portion of said closing element, wherein in said locked position said free end of said closing element is released from said thrusting surface of said male element or “quadrello”.

According to a possible further embodiment, said closing element can be switched from said locked position to a released position, in which said closing element is not engaged with said male element or “quadrello”.

According to a possible further embodiment, said system furthermore comprises a release element suited to switch said closing element from said locked position to said released position in which said closing element is not engaged with said male element or “quadrello”.

According to a possible further embodiment, said release element can be suited to be switched from a first position and a second position, wherein, with said release element in said second position, said closing element is subjected to a thrusting action exerted by a first end portion of said release element and released from said male element or “quadrello”.

According to a possible further embodiment, said release element can be translated along a direction substantially perpendicular to the direction of insertion of said male element in said first corresponding seat created in said female element, wherein said first end portion of said release element possibly extends through said male element or “quadrello”.

According to a possible further embodiment, said release element comprises a second end portion opposite said first end portion and, with said release element in said first position, said second end portion of said release element can be accessed from the outside of said female element, said release element being, if necessary, suited to be switched from said first position to said second position through the exertion of pressure on said second end portion.

Possible further embodiments of the present invention are defined in the claims.

### DETAILED DESCRIPTION OF THE PRESENT INVENTION

The present invention is further clarified here below through the detailed description of its embodiments represented in the drawings, wherein, furthermore, the present invention is not limited to the embodiments represented in the drawings and described in detail here below. In particular, in the drawings:

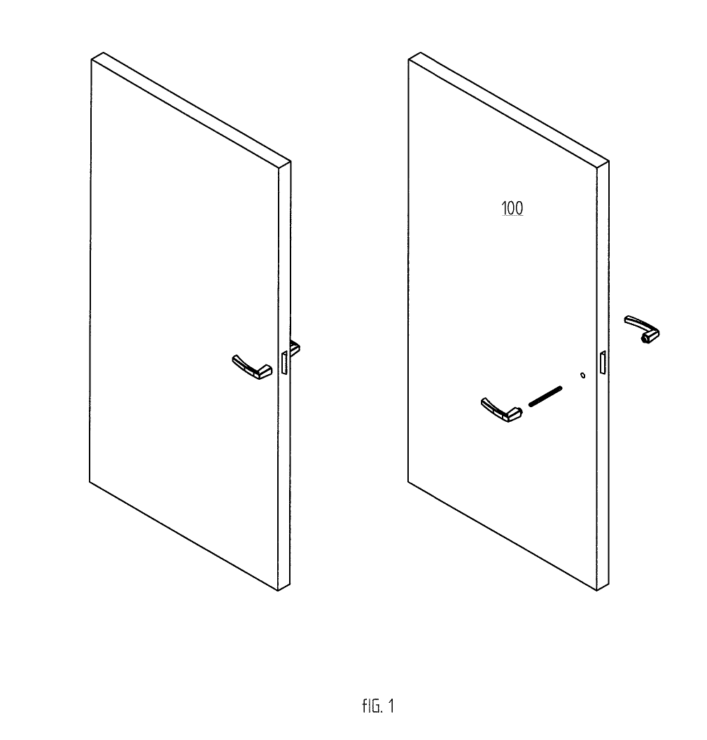

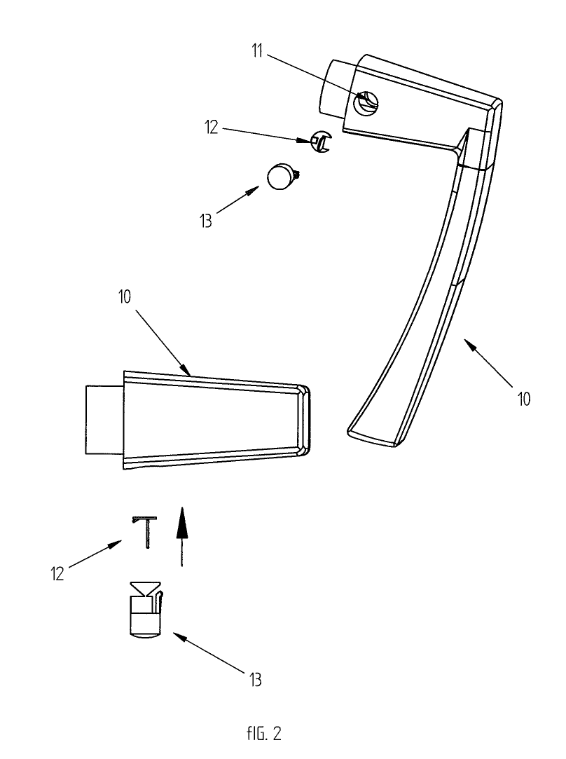

FIG. 1 shows an example of application of a closing system according to an embodiment of the present invention;

FIG. 2 shows plan, side and exploded views of a closing system according to an embodiment of the present invention;

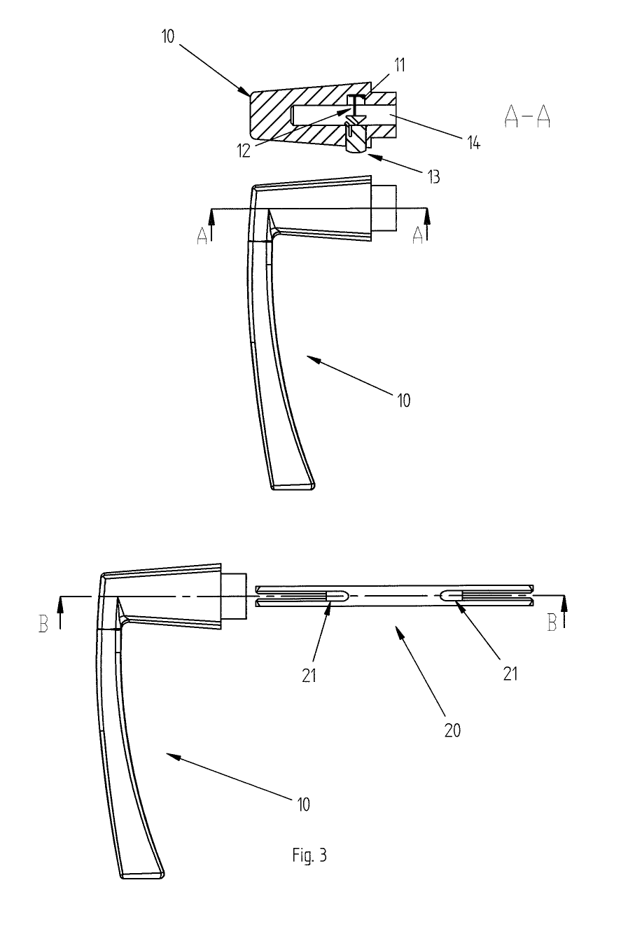

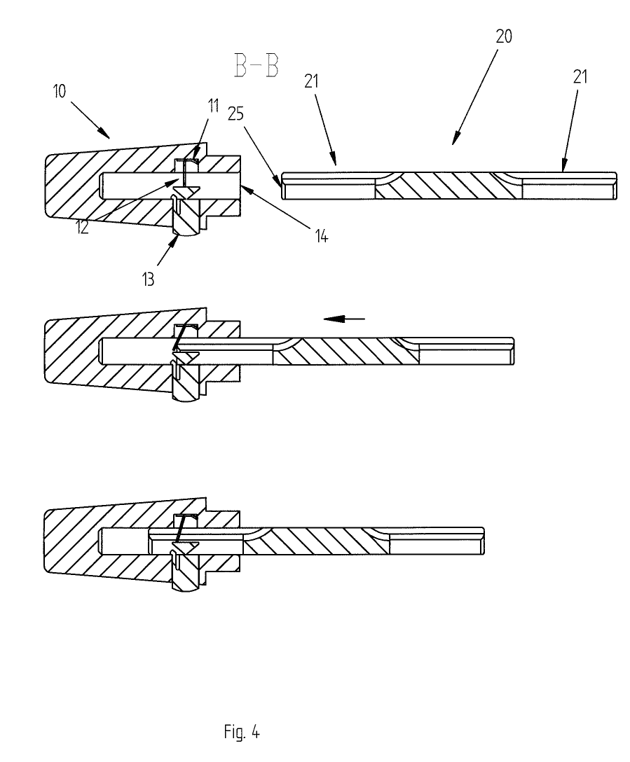

FIG. 3 shows sectional, plan and exploded views of a closing system according to an embodiment of the present invention;

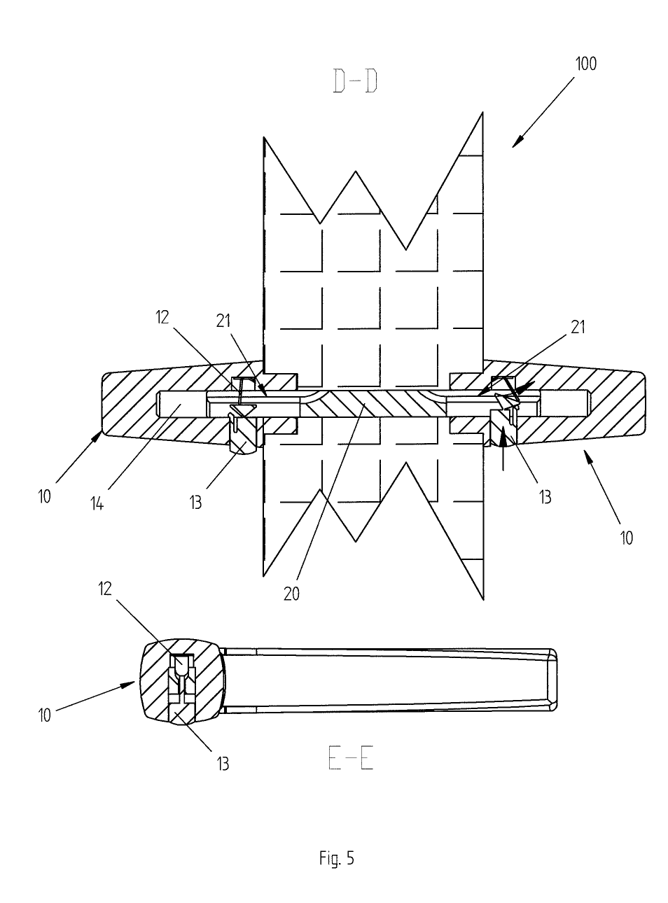

FIG. 4 shows the successive assembly steps of the closing system according to an embodiment of the present invention;

Figures from 5 to 7 show the disassembly steps of the closing system according to an embodiment of the present invention;

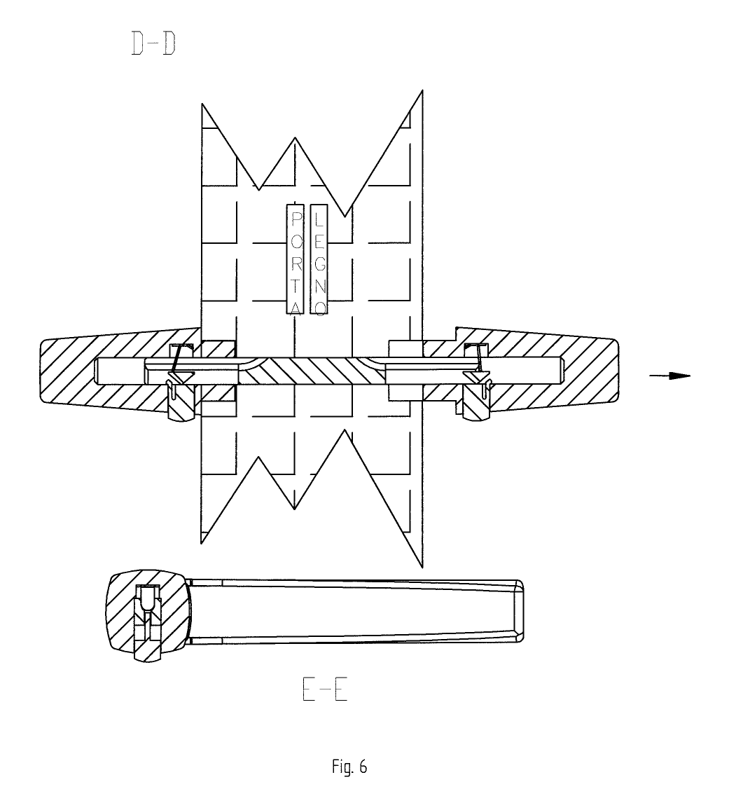

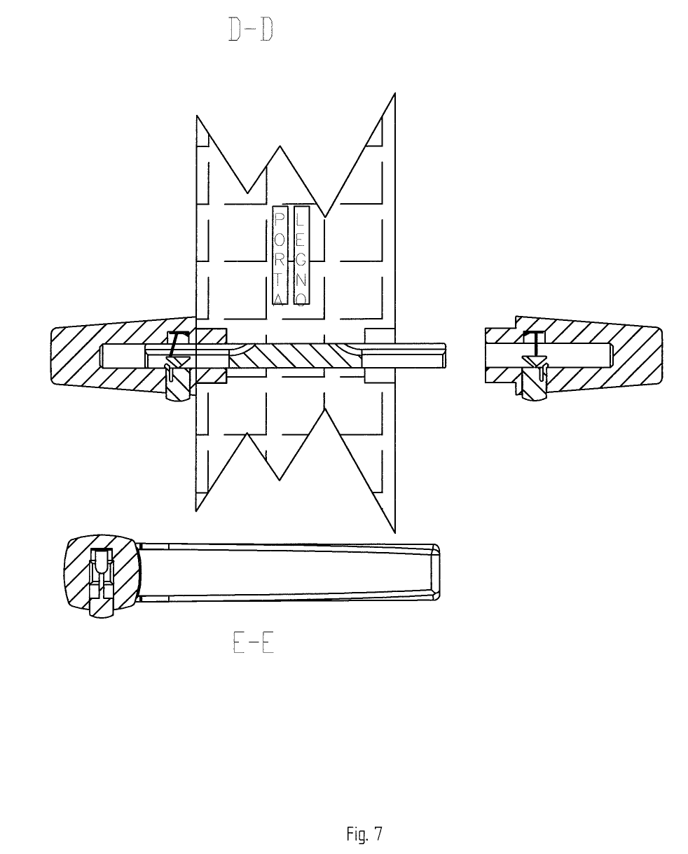

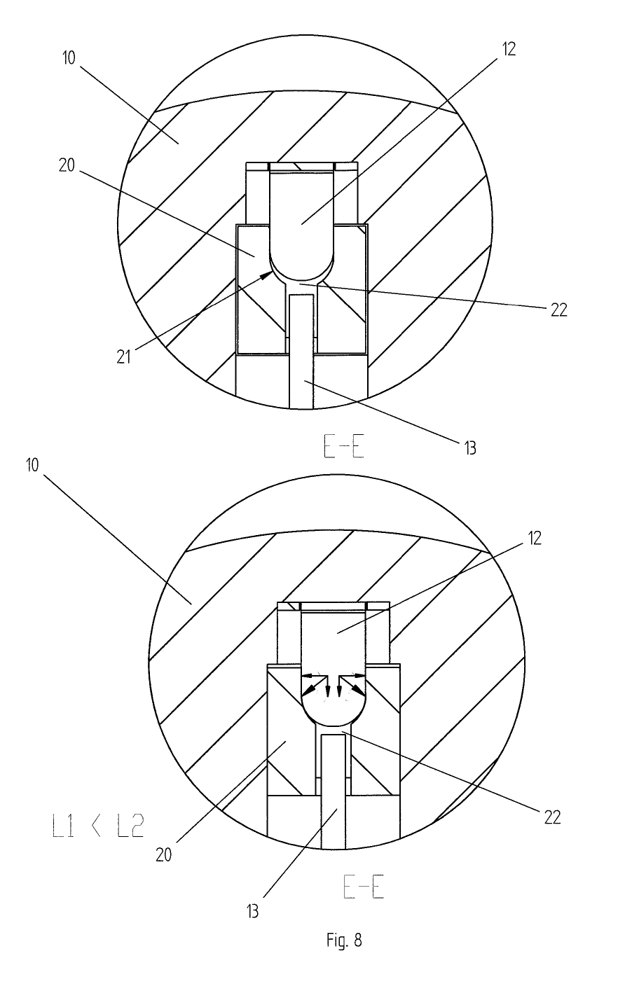

FIG. 8 shows the procedures for mutually constraining the component parts of the closing system according to an embodiment of the present invention;

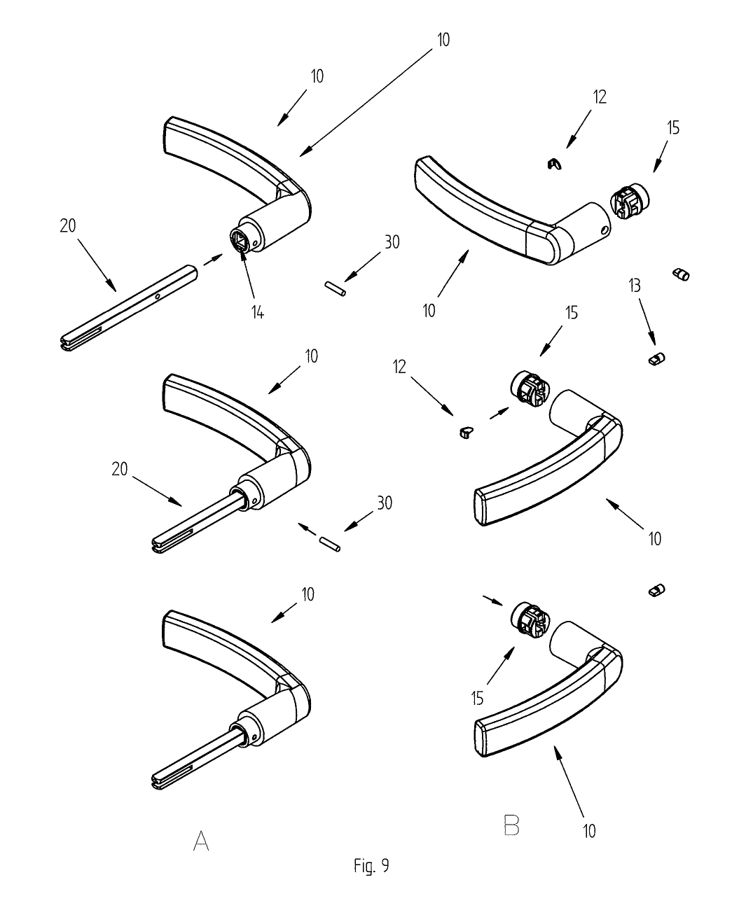

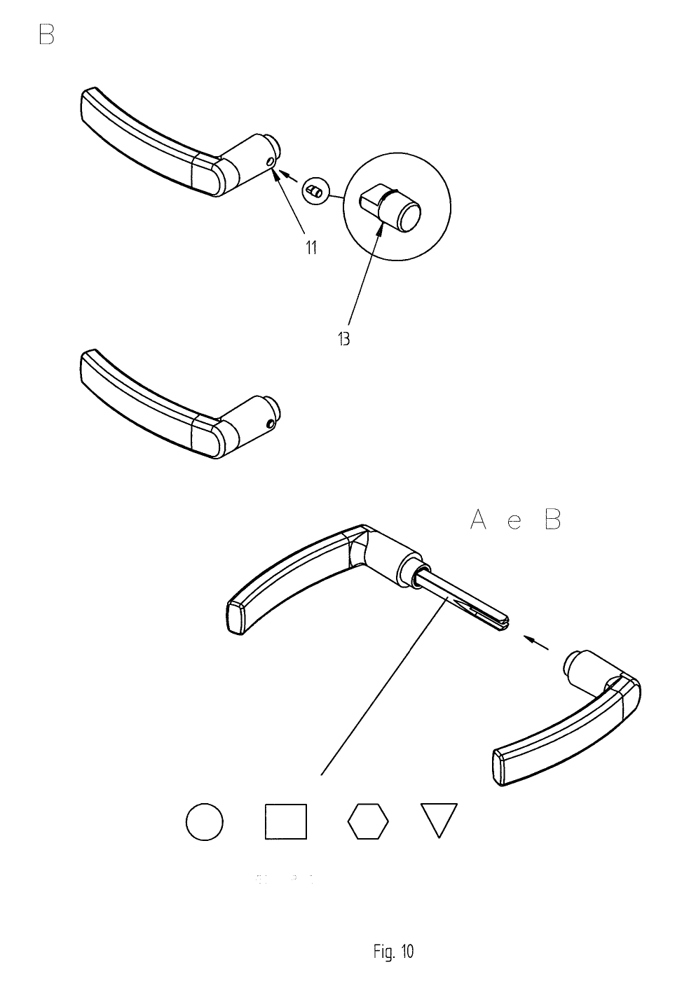

FIGS. 9 and 10 show each perspective and exploded views of a closing system according to an embodiment of the present invention;

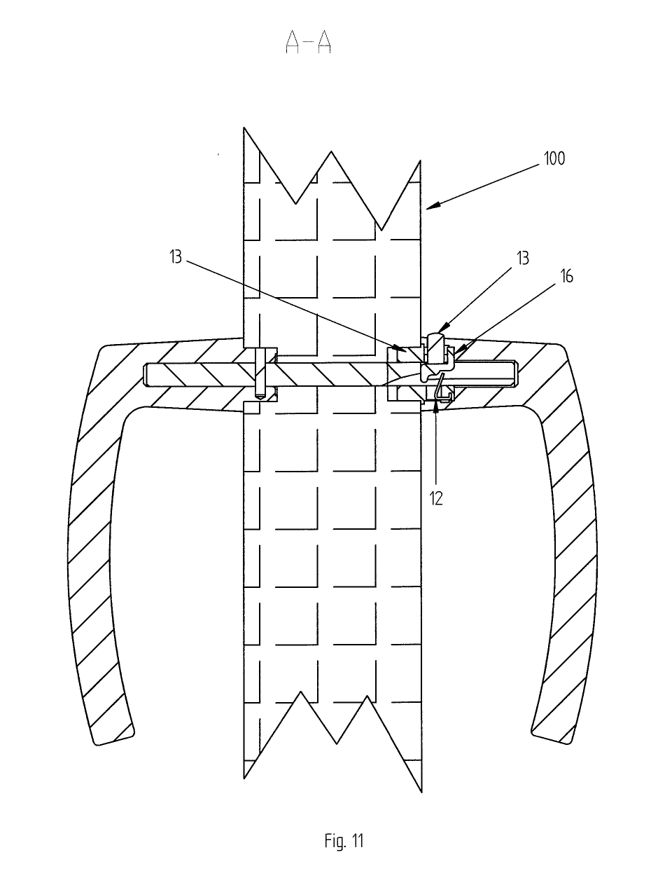

FIG. 11 shows a sectional view of a closing system according to an embodiment of the present invention;

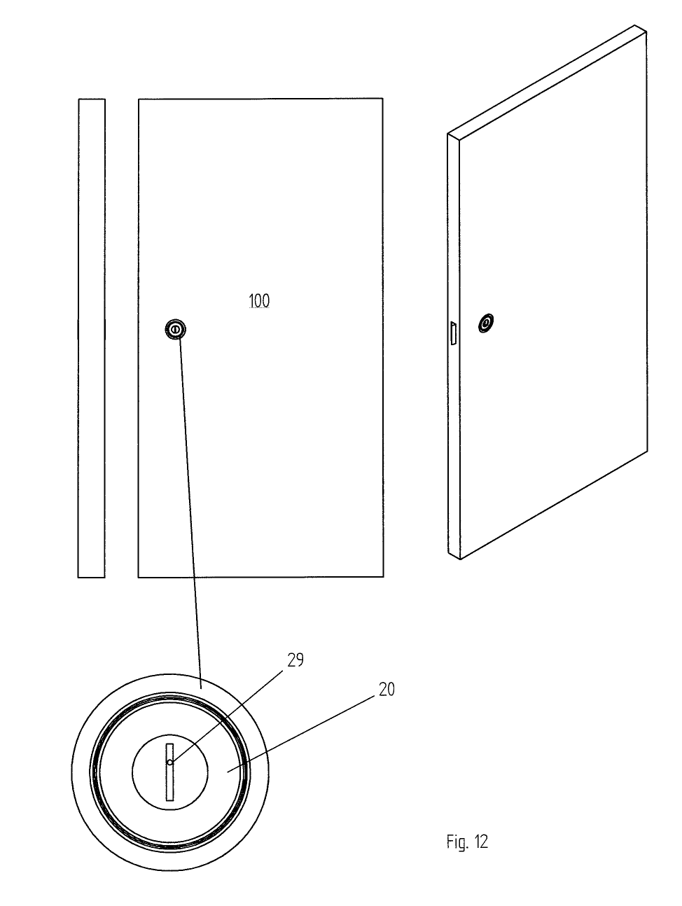

FIG. 12 shows an example of application of a closing system according to an embodiment of the present invention;

Figures from 13 to 15 show the assembly steps of a closing system according to an embodiment of the present invention;

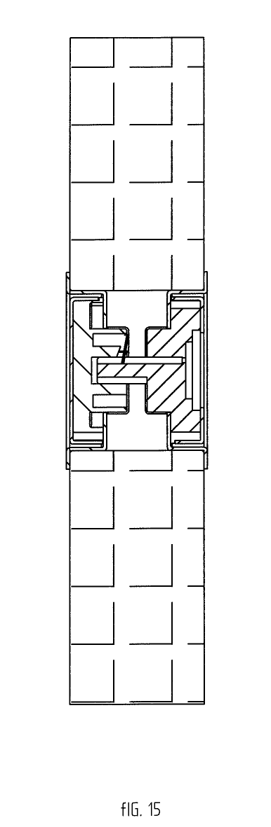

FIG. 16 shows a closing system according to an embodiment of the present invention with its component parts released from each other;

Figures from 17 to 22 show the procedures for mutually engaging the component parts of a corresponding number of closing systems according to the present invention;

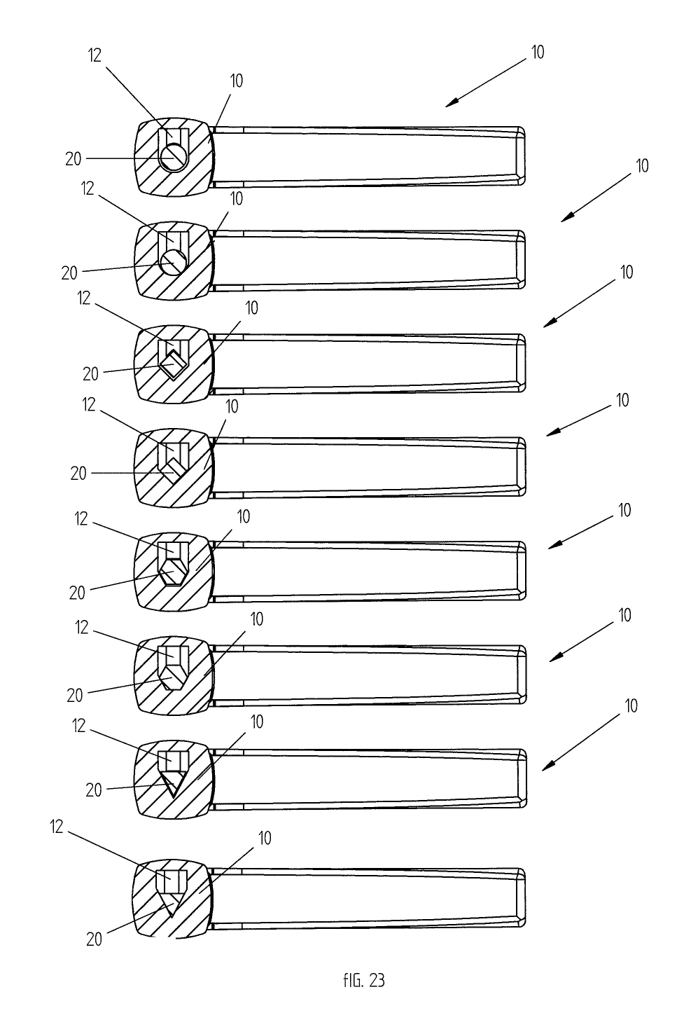

FIG. 23 shows further embodiments of the closing system according to the present invention;

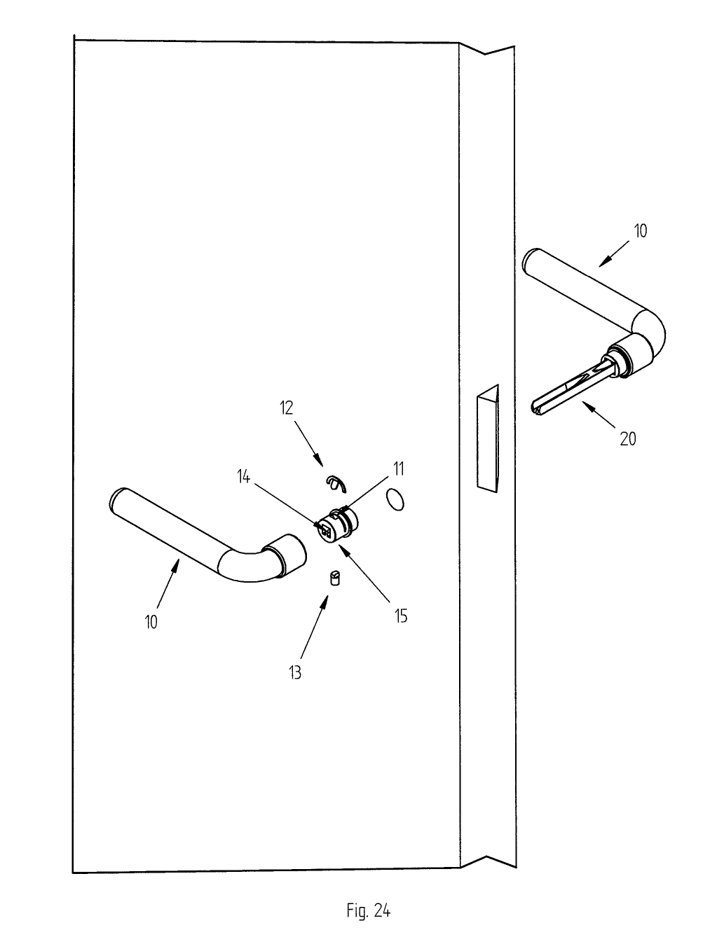

FIGS. 24, 25, 26 and 27 respectively show an exploded view and sectional views of a closing system according to a further embodiment of the present invention.

The present invention can be applied in a particularly advantageous manner to closing systems, in particular closing systems for doors, windows or similar elements. This is the reason why here below the embodiments of the present invention represented in the drawings are described with particular reference to their application to doors/windows as described above. It should however be pointed out that the possible applications of the closing system according to the present invention are not limited to the case of doors/windows as described above; on the contrary, the present invention can be applied as advantageously as in the previous instance in all those cases in which it is necessary to mutually constrain parts of the same system in a reliable manner and through simple procedures, and in particular without using tools or instruments.

FIG. 1 simply shows the application of a closing system according to the present invention to a door/window leaf 100, in this specific case a door leaf, wherein, in particular, a male element or “quadrello” and two handles are respectively applied to the opposite sides of the door leaf 100 (according to procedures that are substantially known and therefore not described in detail herein).

FIGS. 2 and 3 show, instead, some specific details of the closing system according to the present invention.

The figures show, in fact, that at least one handle 10 is provided with a housing seat 11, a first element (closing element) 12 being housed in a first portion of said seat 11, a second element (release element) 13 being housed in a second portion of the same housing seat 11. The handle 10 furthermore comprises a housing seat 14 for the end portion of the male element or “quadrello” 20, wherein the two seats 11 and 14 extend along directions that are substantially perpendicular to each other.

From FIG. 4 it can furthermore be understood that the end portion of the male element 20 intended to be housed in the seat 14 created in the handle 10 comprises a groove or lowered portion 21 (see also FIG. 8).

The closing element 12, made in a flexible and/or elastic material, preferably metal but also plastic or similar materials, furthermore comprises a flexible plate that, in the rest position shown in FIG. 3, substantially extends at right angles to the direction of insertion of the male element 20 in the handle 10, in particular in the seat 14 created in the handle 10. The release element 13 is positioned in the seat 11 in a position corresponding to that of the closing element 12, and can be switched inside the seat 11 in such a way as to be respectively moved near the plate of the element 12, in particular until coming into contact with it and pushing it so as to switch it (see also the following description), and moved away from the plate of the closing element 12.

The assembly of the closing system, in particular the mutual closing of the male element 20 and the handle 10 (hereinafter also referred to as female element) starts from the configuration shown at the top in FIG. 4, in which the end of the release element 13 opposite the plate of the closing element 12 is positioned at a minimum distance from the plate itself, or also in such a way as to be in contact with it, but however without exerting any action on the plate of the closing element 12. The assembly then proceeds as shown in the centre part of FIG. 4, in particular with the insertion of the end of the male element 20 in the seat 14 created in the handle 10. In this regard, it should be pointed out that, in order for the release element 13, in particular its end housed in the seat 14, not to represent an obstacle to the insertion of the male element 20 in the seat 14, the male element 20 comprises a through opening 22 (see also FIG. 8) intended to accommodate the end of the release element 13, and thus to allow the insertion of the male element 20 in the corresponding seat 14 created in the handle 10. It should also be noticed that the end of the male element 20 intended to be inserted in the corresponding seat 14 created in the handle 10 comprises a lowered portion (a groove with shape and size substantially corresponding to those of the plate of the closing element 12), wherein the male element 20 (its end portion) comprises a front surface 25.

In particular, it can be observed in the centre part of FIG. 4 that the front surface 25 of the male element 20, during the insertion of the same in the handle 10, comes into contact with the free end of the plate of the closing element 12 (housed in the seat 14), thus exerting a thrusting action on said free end in such a way as to switch it from the start position (substantially perpendicular to the direction of insertion of the male element 20) to a different position in which the plate is oriented, with respect to the direction of insertion of the male element 20—in such a way as to define an angle different from 90° with the same direction of insertion.

Proceeding with the insertion of the male element 20 in the handle 10, as shown at the bottom of FIG. 4, a loss of contact takes place between the free end of the plate and the thrusting surface 25, wherein the plate, thanks to its flexibility and/or elasticity, comes to be positioned in the groove 21 of the male element 20. It can also be understood that, as the male element 20 at this point is inserted in the handle 10, the same male element 20 will prevent the automatic return of the plate in its start position, wherein the plate, on the contrary, will be locked in the position shown at the bottom of FIG. 4. It can thus be also understood that, at this point, any attempt to extract the male element 20 from the handle 10 again (if not with the release procedures described below), will be nullified by the counteracting action exerted by the plate which, on the contrary, as a response to any traction exerted on the male element 20 and/or on the handle, will exert pressure on the male element 20 and thus will become even more engaged with the male element 20. At this point, therefore, the male element 20 and the handle 10 are mutually constrained to each other, wherein the mutual constraint of the male element 20 and the handle 10 has been obtained without using tools and/or instruments but, on the contrary, by simply inserting the male element 20 in the handle 10.

Figures from 5 to 7, in which component parts and/or characteristics of the closing system according to the present invention, already described above with reference to other figures, are identified by the same reference numbers, show the procedures for releasing the male element 20 and the handle 10 from each other, and in particular the function of the release element 13.

In fact, it can be understood from the figures that when pressure is exerted on the release element 13 (on the right in the figures), in such a way as to insert it deeper in the seat 11, its end portion opposite the closing element 12 will become engaged with the free end of the plate of the element 12 and thus switch it further until releasing it from the groove 21 obtained in the male element 20. In this way, the plate of the closing element 12 is positioned in such a way that it does not represent any more an obstacle to the mutual movement of the male element 20 and the handle 10, so that the handle 10 can be removed from the male element 20.

FIG. 8, in which once again the component parts and/or the characteristics of the closing system according to the present invention, already described above with reference to other figures, are identified by the same reference numbers, makes it possible to appreciate some specific features and/or characteristics of the component parts of the closing system.

In fact, it can be understood from FIG. 8 that the free end of the plate of the closing element 12 and the groove 21 of the male element 20 have substantially corresponding shape and size, wherein the external edge of the plate is in contact with the surface of the groove 21, preventing the mutual movement of the male element 20 and the handle 10 as described above.

The left part of FIG. 9 shows how, according to the present invention, only one of the handles can be constrained to the male element 20 according to the procedures described above, while the other handle can be constrained to the male element 20 according to procedures known in the art, in particular by using a threaded dowel 30.

On the contrary, the right part of FIG. 9 shows an alternative embodiment of the present invention, according to which, in particular, the closing system comprises an additional element 15 intended to be housed in the handle 10, wherein in this case it is the additional element 15 that defines the housing seats 14 and 11 respectively for the end of the male element 20 and the closing element 12.

The advantage offered by this embodiment is related to the fact that in this case it is possible to arrange the closing element 12 in the additional element 15 before positioning the additional element 15 in the handle 10 and possibly even before positioning the release element 13 in the respective housing seat created in the handle 10.

The right part of FIG. 10 shows that, according to the present invention, it is possible to choose the shape of the cross section of the male element 20 according to the needs and/or circumstances, wherein the cross section of said male element 20, in particular, can be square or rectangular, hexagonal, triangular or in any case polygonal.

The embodiment illustrated in FIG. 11 is differentiated from the embodiments described above in that the release element 13 is made up of two portions, in particular of one portion suited to be operated under pressure and of a portion 16 suited to be switched, in particular translated, as a response to the movement of the part operated under pressure, and thus to act on the free end of the plate of the closing element 12, wherein the procedures for switching the closing element 12 are substantially similar to those described above, so that a detailed description of the same is omitted for the sake of brevity.

In the embodiment of the closing system according to the present invention illustrated in Figures from 12 to 16 handles are used which are different from those used in the embodiments described above and represented in Figures from 1 to 11, wherein the present embodiment includes, in particular, the use of handles suited to be mutually constrained and to be recessed into a leaf 100, for example of a door, a window or a similar element.

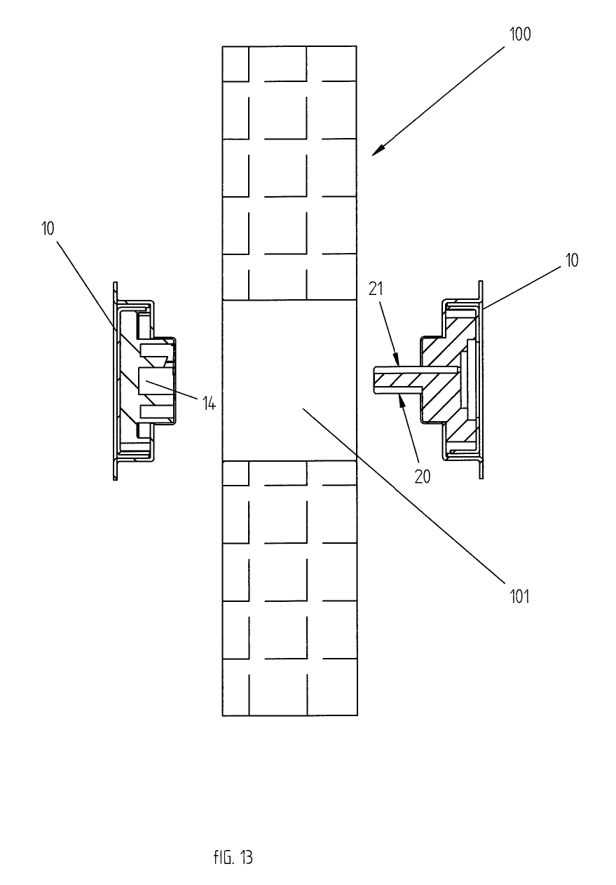

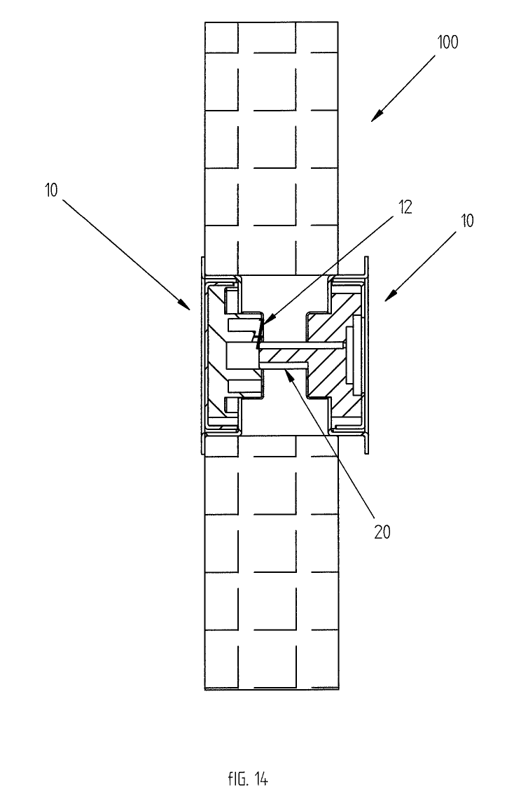

According to the present embodiment, the male element 20 is an integral part of one of the two handles, in particular, in this specific case, of the handle shown on the right in Figures from 13 to 15, wherein said male element, on the other hand, is substantially similar to those described above, especially in relation to the shape of its “free” end portion intended to be constrained to the other handle 10 (on the left in Figures from 13 to 15), in particular to be inserted and housed in a corresponding seat 14 created in the second handle 10. Said free end of the male element, in fact, comprises also a lowered portion 21 intended to interact with a plate of a closing element 12 according to the procedures described above. The assembly of the closing system according to the present embodiment is thus carried out starting from the configuration shown in FIG. 13, and thus moving the two handles 10 near each other and moving the two handles 10 near the door/window leaf 100, until positioning them at the level of the housing seat 101 obtained in the door/window leaf 100 itself (FIG. 14). The mutual approach of the two handles 10, with the consequent progressive insertion of the male element 20 in the corresponding housing seat, will switch the closing element 12 according to the procedures described above, wherein the plate of the closing element 12 will become engaged with the groove 21 created in the male element 20, in particular wherein the external edge of the plate will come into contact with the surface of the groove 21 of the male element 20. FIG. 15 shows, in particular, the condition of mutual constraint of the two handles 10, the two handles thus being also constrained to the door/window leaf 100.

A further specific feature of the closing system according to the present embodiment is related to the procedures for the mutual release of the two handles 10 from each other. In the case of this embodiment, in fact, “lateral” access to the closing element 12 being excluded, a tool 30 is used, for example a small needle-shaped bar that is inserted for this purpose into a hole 29 (FIGS. 12 and 16) until exerting a thrusting action on the plate of the closing element 12, in such a way as to obtain the switching of the release element 12 from the locked position to the released position according to procedures that are substantially similar to those described above.

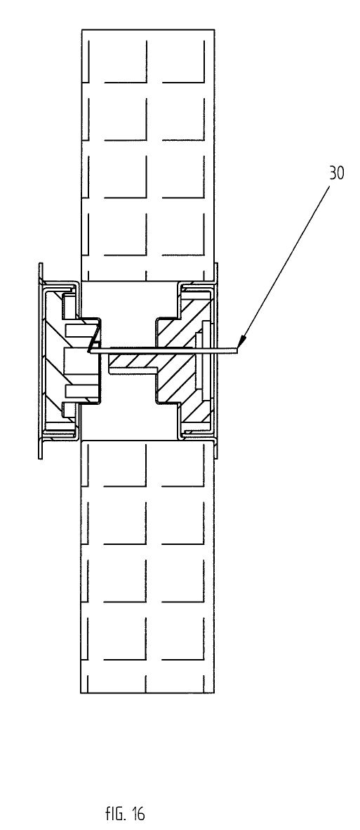

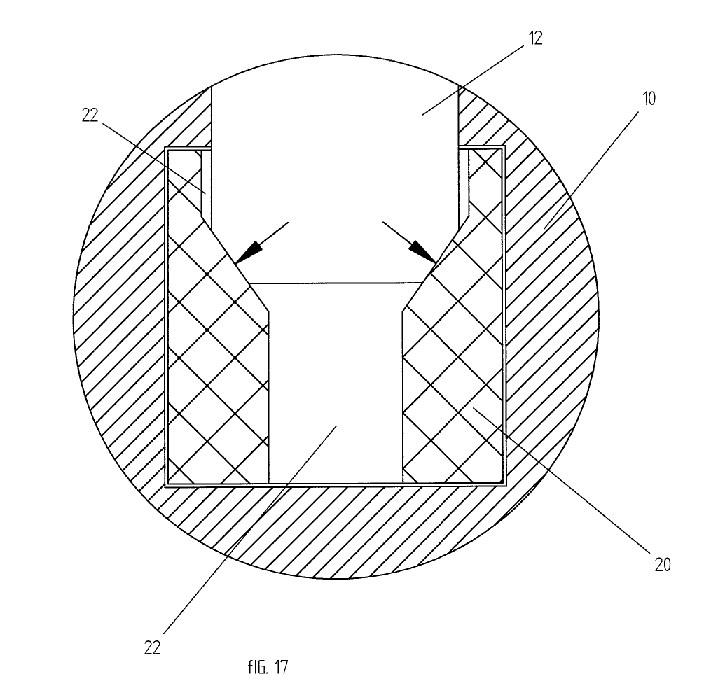

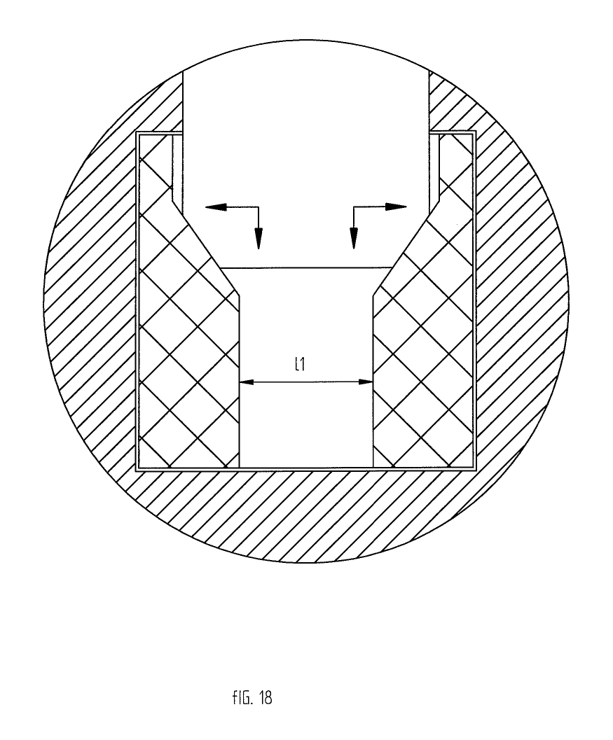

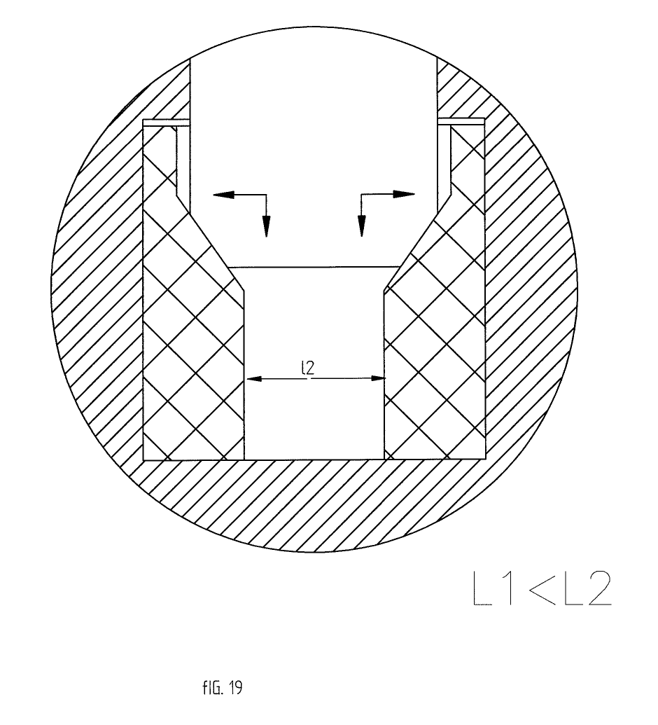

Figures from 17 to 19 and from 20 to 22 show some different embodiments of the plate of the closing element 12 and the groove 21 of the male element 20. According to the solution illustrated in Figures from 17 to 19, the groove 21 comprises two opposite side walls arranged so as to form a V, wherein the plate comprises two bevelled portions each one of which is intended to interact with one of said opposite side walls of the groove 21, in particular each one of which is intended to come into contact with one of the two opposite walls of the groove 21. The advantage offered by this solution lies in that it allows the resolution of the counteracting forces between the plate and the male element, and thus to enhance the engagement between the plate and the male element 20, as indicated by the arrows. In particular, the opposition between the bevelled portions of the plate 12 and the corresponding opposite side walls of the groove 21 generates the forces indicated by the oblique arrows in FIG. 17. In particular, each one of these forces is the resultant of two perpendicular forces as shown in FIGS. 18 and 19, wherein FIG. 19 shows how, under the action of the forces, the “quadrello” 20 expands (L2>L1), thus increasing also the opposition between the “quadrello” 20 and the seat in which the “quadrello” is housed, with clearly enhanced mutual engagement between the involved parts and thus with the elimination of any slacks.

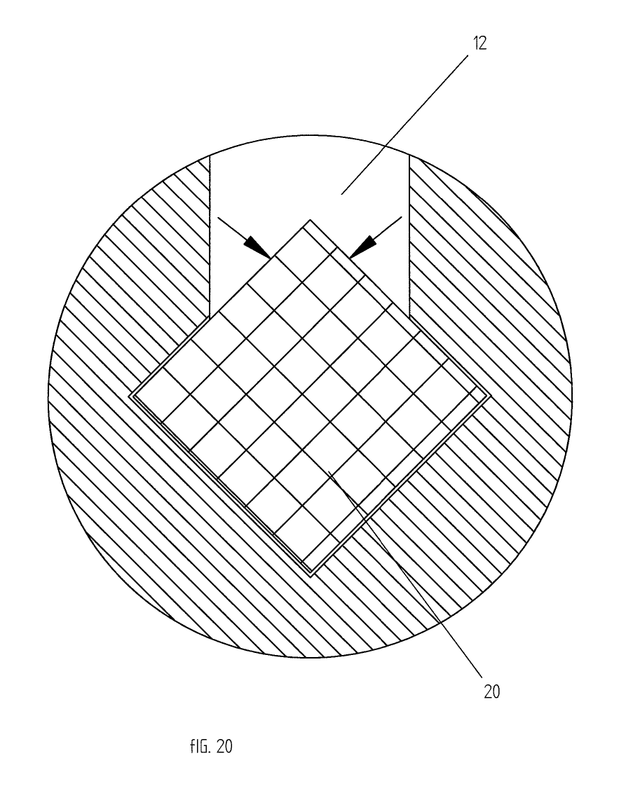

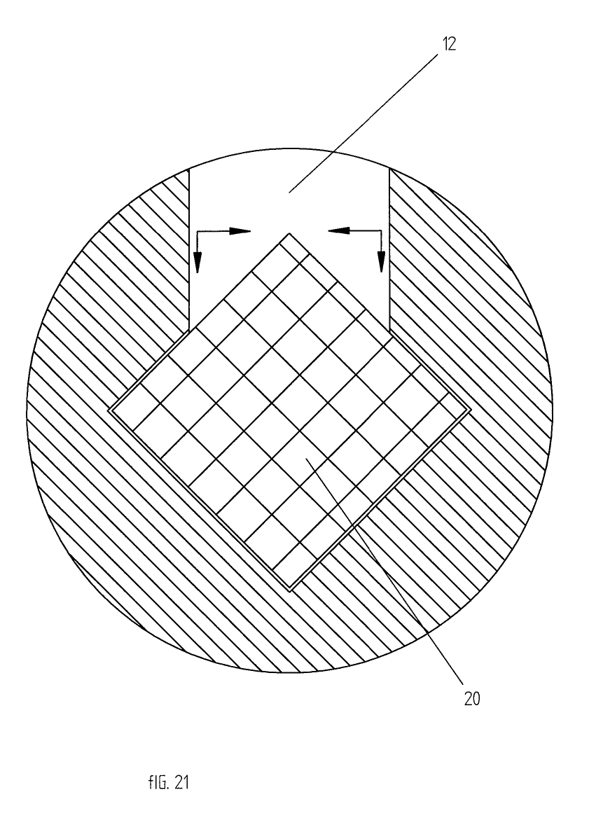

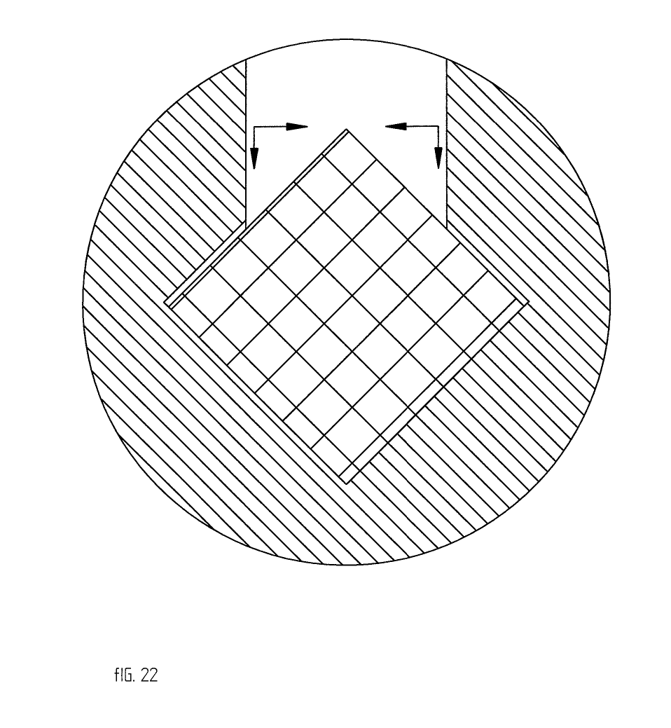

According to the solution shown in Figures from 20 to 22, according to which the male element has a substantially square cross section and has no grooves and the free end of the plate comprises an edge defined by two rectilinear sections arranged so as to form a V, each one of the two rectilinear sections is intended to interact with a corresponding side of the male element 20. Also in this case, each one of the forces represented by the oblique arrows in FIG. 20 represents the resultant of two perpendicular forces (see the arrows in FIGS. 21 and 22). However, in this case the “expansion” of the “quadrello” is negligible, while the thrusting effect exerted by the plate 12 on the “quadrello” 20 so as to thrust it against the walls of the housing of the “quadrello” itself prevails.

FIG. 23 shows further possible embodiments, each one of which is related to a possible cross section of the “quadrello” and of the end of the plate; in all of these embodiments, the “expansion” of the “quadrello” is negligible, while the thrusting effect exerted by the plate 12 on the “quadrello” 20 so as to thrust it against the walls of the housing of the “quadrello” prevails (note how for each embodiment the opposition between plate and “quadrello” has the effect to “close” the air space between the “quadrello” 20 and its housing seat.

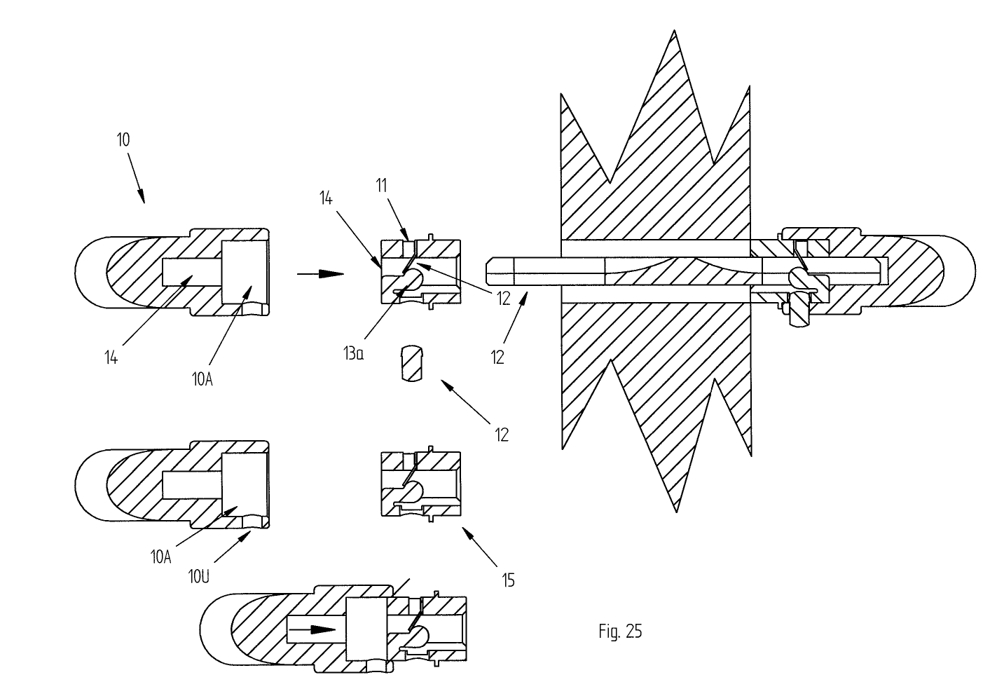

A further possible embodiment of the closing system according to the present invention is described here below with reference to Figures from 24 to 27. The embodiment illustrated in Figures from 24 to 27 is similar to that shown in FIG. 9 and described above; in fact, in Figures from 24 to 27 it is possible to identify not only the handle 10, the male element 20, the closing element 12 and the release element 13, but also the intermediate additional element 15. The specific features of this embodiment are related to the shape of the closing element 12, as well as to the shape and purpose of the intermediate element 15. In fact, the closing element 12, in addition to the usual flexible or elastic plate (common to all the embodiments), comprises also a supporting and fixing element having the shape of an arc of a circle and intended to be housed in a correspondingly shaped housing portion of the seat 11 created in the intermediate element 15 (FIG. 25). The positioning of the element 12 in the corresponding seat 11 can thus be carried out from the outside, wherein when the semicircular portion of the element 12 is positioned in the corresponding portion of the seat 11, the plate of the element 12 extends at least partially into the housing seat 14 that accommodates the male element 20. The seat 11 is substantially a through seat, as it communicates with the outside through two opposite outlets, of which the first one (on top in FIG. 25) allows the insertion of the element 12, while the second one (opposite the first and thus at the bottom in FIG. 25) allows the insertion of the release element 13 according to the procedures described above. The second outlet, on the other hand, is partially obstructed by an elastic release element 13A belonging to the intermediate element 15, wherein the operation of the plate (for the release of the male element 20) is obtained once again by exerting pressure on the element 13, which however in this case does not push the plate directly, but instead pushes the element 13A, which is thus set rotating (counter clockwise with respect to the figures) and so acts on the plate, which is then set rotating (clockwise with respect to the figures) and so released from the male element or “quadrello” 20.

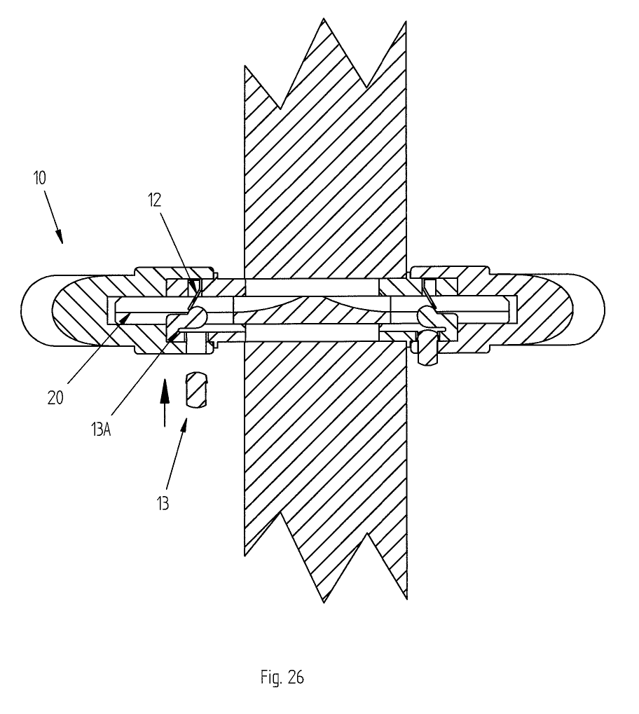

The assembly of the closing system according to the present embodiment can thus include, for example, the following steps in succession: insertion/positioning of the element 12 in the intermediate element 15 through the free outlet of the seat 11; insertion of the element 15 in the seat 10A created in the handle 10 (note how in this way the free outlet of the seat 11 is closed by the external wall of the seat 10A, thus avoiding the risk of the element 12 accidentally moving out of the seat 11; furthermore, the outlet of the seat 11 partially obstructed by the element 13A in this way comes to be positioned at the level of an outlet 10U of the seat 10); insertion of the release element 13 in the seat 11 through the outlet 10U; insertion of the male element or “quadrello” 20 in the seats 14 created in the element 15 and the handle 10. The final situation of mutual constraint between the male element 20, the intermediate element 15 and the handle 10 is represented in FIG. 26. The release of the system takes place according to procedures already described above, so that a detailed description of the same is omitted for the sake of brevity.

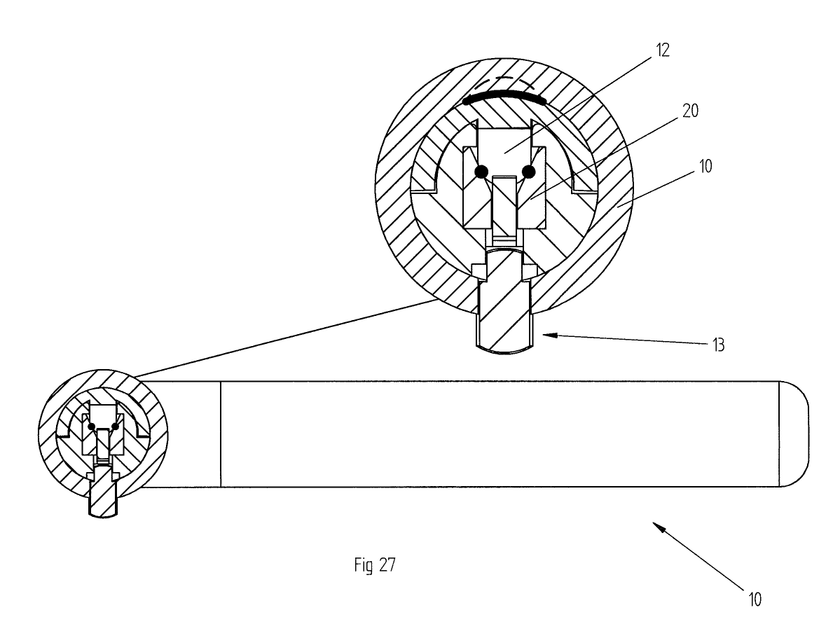

A further specific feature of the embodiment just described above with reference to Figures from 24 to 26 is represented in FIG. 27; in fact, it can be understood that in this case the peripheral edge (free) of the plate is semicircular, while the seat 21 of the male element 20 has polygonal cross section with two opposite inclined walls. In the figure it is possible to observe the contact points between the semicircular free edge of the plate and the opposite walls of the seat 21 of the element 20, as well as the opposition area (in bold) between the portion of the element 12 in the shape of an arc of a circle and the opposite portion of the handle 10. This solution makes it possible to increase not only the opposition between the plate and the element 20 (when one tries to extract the element 20 without acting on the plate through the element 13), but also the opposition between the element 15 and the handle 10.

Furthermore, as indicated with a broken line in FIG. 27, it is possible to include a projection of the portion of the element 12 in the shape of an arc of a circle (on the opposite side with respect to the plate), which is engaged with a corresponding seat created in the handle 10, thus avoiding mutual rotation movements between the involved parts or components.

It has thus been shown, through the detailed description of the embodiments of the present invention illustrated in the drawings provided above, that the present invention makes it possible to achieve the set objects and/or to overcome or minimize the drawbacks found in the known art. In fact, the present invention makes it possible to mutually and reliably fasten one or both the handles of a closing system to the corresponding male element or “quadrello”. Furthermore, the present invention allows the assembly and disassembly of the closing system, in particular it makes it possible to mutually fasten and constrain at least some of the component parts of a closing system with no need to use any specific tools and/or instruments.

Furthermore, the solution according to the present invention is compatible with the aesthetic appearance of the handle or at least is such as not to affect said aesthetic appearance of the handle.

And again, the solution according to the present invention makes it possible to avoid any accidental uncoupling of the component parts of a closing system, in particular of one or both the handles from the male element or “quadrello”. Furthermore, according to the present invention the closing system can be carried out and assembled by means of simple or not excessively complicated operations and procedures, at a limited or at least competitive cost.

Even though the present invention has been illustrated by means of the preceding detailed description of its embodiments represented in the drawings, the present invention is not limited to the embodiments described above and represented in the drawings. On the contrary, all those variants of the embodiments described herein and represented in the drawings that are clear and obvious to those skilled in the art fall within the scope of the present invention.

For example, the release element or button 13 can both be housed in the corresponding seat and kept at disposal separately in order to release the handle if this is needed and/or convenient, or even not be provided as component part of the system according to the present invention, wherein in this case the handle can be released by means of any tool (for example, a pointed tool) suitable for this purpose.

The scope of the present invention is then defined in the claims. CLAIMS

1. Closing system for doors/windows, said system comprising a first male element (20), also commonly called “quadrello” in Italian, intended to move a bolt by rotating it, and a second female element (10) suited to be operated in such a way as to set said male element or “quadrello” (20) rotating, said male and female elements (20, 10) being suited, when in use and/or when applied to a door/window, for example, to be mutually fixed in a configuration of use, wherein in said configuration of use or operation an end portion of said male element (20) is housed in a first corresponding seat (14) created in said female element (10), said system comprising a closing element (12) suited to mutually lock said male and female elements (20, 10) in said configuration of use or operation, characterized in that said closing element (12) is housed in a second corresponding seat (11) created in said female element (10), and in that said closing element (12) is configured in such a way that it can be switched in a locked position in which it is engaged with said male element or “quadrello” (20) through the insertion of said end portion of said male element or “quadrello” (20) in said first corresponding seat (14) created in said female element (10).

2. System according to claim 1, characterized in that said closing element (12) is shaped in such a way that, once it has been switched in said locked position, any movement of said male element (20) or said female element (10) in the direction opposite the direction of insertion of said end portion of said closing element (12) in said first corresponding seat (14) created in said female element (10) enhances the mutual engagement of said closing element (12) and said male element or “quadrello” (20).

3. System according to claim 1 or 2, characterized in that said closing element (12) comprises a flexible portion, in that said flexible portion, when not engaged with said male element (20), extends along a first rest direction, and in that said flexible portion, when switched in said locked position, extends along a second direction that is different from said first direction.

4. System according to claim 3, characterized in that said first direction is substantially perpendicular to the direction of insertion of said male element (20) in said first seat (14) created in said female element (10).

5. System according to any of the claims from 1 to 4, characterized in that said closing element (12) comprises a free end portion whose position can be switched, and in that, in said engaged position, said free end portion is engaged with said male element or “quadrello” (20).

6. System according to claim 5, characterized in that, in said locked position, said free end portion of said closing element is engaged with a groove or lowered portion created in said male element.

7. System according to claim 6, characterized in that, in said locked position, the external edge of said closing element is in contact with the surface of said groove or lowered portion.

8. System according to any of the claims from 5 to 7, characterized in that said male element or “quadrello” comprises a thrusting surface that, during the insertion of said male element in said corresponding seat created in said female element, thrusts said free end portion of said closing element, and in that, in said locked position, said free end of said closing element is released from said thrusting surface of said male element or “quadrello”.

9. System according to any of the claims from 1 to 8, characterized in that said closing element can be switched from said locked position to a released position, in which said closing element is not engaged with said male element or “quadrello”.

10. System according to claim 9, characterized in that said system furthermore comprises a release element suited to switch said closing element from said locked position to said released position, in which said closing element is not engaged with said male element or “quadrello”.

11. System according to claim 10, characterized in that said release element can be switched between a first position and a second position, and in that, with said release element in said second position, said closing element is subjected to a thrusting action exerted by a first end portion of said release element and is released from said male element or “quadrello”.

12. System according to claim 11, characterized in that said release element can be translated along a direction that is substantially perpendicular to the direction of insertion of said male element in said first corresponding seat created in said female element.

13. System according to claim 11 or 12, characterized in that said first end portion of said release element extends through said male element or “quadrello”.

14. System according to any of the claims from 11 to 13, characterized in that said release element comprises a second end portion opposite said first end portion, and in that, with said release element in said first position, said second end portion of said release element can be accessed from the outside of said female element.

15. System according to claim 14, characterized in that said release element is suited to be switched from said first position to said second position by exerting pressure on said second end portion of said release element.
